(19) United States
(12) Patent Application Publication
(10) Pub. No.: US 2007/0126158 A1
(43) Pub. Date: Jun. 7, 2007

(54) Method of cleaning polymeric mold

(75) Inventors: Yusuke Saito, Yamato-city (JP); Yorinobu Takamatsu, Sagamihara-city (JP); Hiroshi Kikuchi, Yamato-shi (JP); Akira Yoda, Machida-city (JP); Toru Aoki, Sagamihara-shi (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/296,715

(22) Filed: Dec. 1, 2005

(51) Int. Cl. C08J 5/00

(52) U.S. Cl. 264/496; 264/39; 264/236; 264/331.18

(57) ABSTRACT

The present invention relates to methods of cleaning microstructured molds and methods of making microstructures (e.g. barrier ribs).

### BACKGROUND

Advancements in display technology, including the development of plasma display panels (PDPs) and plasma addressed liquid crystal (PALC) displays, have led to an interest in forming electrically-insulating barrier ribs on glass substrates. The barrier ribs separate cells in which an inert gas can be excited by an electric field applied between opposing electrodes. The gas discharge emits ultraviolet (UV) radiation within the cell. In the case of PDPs, the interior of the cell is coated with a phosphor that gives off red, green, or blue visible light when excited by UV radiation. The size of the cells determines the size of the picture elements (pixels) in the display. PDPs and PALC displays can be used, for example, as the displays for high definition televisions (HDTV) or other digital electronic display devices.

One method barrier ribs can be formed on a glass substrate is by direct molding. This has involved laminating a mold onto a substrate with a glass- or ceramic-forming composition disposed therebetween. Suitable compositions are described for example in U.S. Pat. No. 6,352,763. The glass- or ceramic-forming composition is then solidified and the mold is removed. Finally, the barrier ribs are fused or sintered by firing at a temperature of about 550° C. to about 1600° C. The glass- or ceramic-forming composition has micrometer-sized particles of glass frit dispersed in an organic binder. The use of an organic binder allows barrier ribs to be solidified in a green state so that firing fuses the glass particles in position on the substrate.

### SUMMARY OF THE INVENTION

When barrier ribs are formed by methods of direct molding, it is economical and reduces waste to reuse the same mold. In order to extend the number of times the mold can be reused, a method of cleaning a polymeric (e.g. microstructured) mold has been developed.

In one embodiment, a method of cleaning a mold is described. The method comprises providing a mold having a polymeric microstructured surface suitable for use in molding a curable molding material and cleaning the mold by
providing a flowable solidifiable cleaning composition on the microstructured surface of the mold wherein the cleaning composition is different than the curable molding material;
solidifying the cleaning composition; and
removing the solidified cleaning composition.

In another embodiment, a method of making a display panel component is described. The method comprises providing a mold having a polymeric microstructured surface (e.g. suitable for making barrier ribs), placing a curable rib precursor composition between the microstructured surface of the mold and a (e.g. electrode patterned) substrate, curing the precursor material, removing the mold, cleaning the mold (as just described), and reusing the cleaned mold.

The mold preferably has a roughness of less than 1 micron after cleaning. The microstructured surface of the mold has substantially the same microstructure dimensions after cleaning. The mold is preferably flexible. The microstructured surface of the mold may comprise a cured polymeric material optionally disposed on a polymeric support film. The rib precursor material may comprise photoinitiator and may be photocured through the patterned substrate, though the mold, or a combination thereof. The rib precursor typically comprises inorganic particulate material, a curable organic binder and diluent.

The cleaning composition typically comprises ingredients selected from a curable organic binder, optionally a diluent and optionally a particulate inorganic material. The cleaning composition comprises at least one ingredient that is different than the rib precursor or the same ingredients as the rib precursor at different concentrations. The solubility parameter of the diluent of the cleaning composition is equal to or less than the solubility parameter of the curable organic binder, e.g. by a difference of greater than 2 [MJ/m³]^{1/2}. The curable organic binder of the cleaning composition typically comprises at least one (meth)acryl oligomer having at least two (meth)acrylate groups such as (meth)acrylated epoxy, (meth)acrylate urethane, (meth)acrylated polyether, (meth)acrylated polyester, (meth)acrylated polyolefin, (meth)acrylated (meth)acrylic, and mixtures thereof.

### BRIEF DESCRIPTION OF THE DRAWINGS

FIG. 1 is a perspective view of an illustrative flexible mold suitable for making barrier ribs.

FIG. 2A-2C is a sectional view, in sequence of an illustrative method of making a fine structure (e.g. barrier ribs) by use of a flexible mold.

FIG. 3A-3C is a sectional view, in sequence of an illustrative method of cleaning a (e.g. microstructured mold).

FIG. 4 is a photomicrograph of an exemplary microstructured mold prior to cleaning.

FIG. 5 is a photomicrograph of an exemplary microstructured mold after cleaning.

### DETAILED DESCRIPTION OF THE PREFERRED EMBODIMENTS

The present invention relates to methods of cleaning microstructured molds and methods of making microstructures (e.g. barrier ribs). Hereinafter, the embodiments of the invention will be explained with reference to method of making barrier rib microstructures with a (e.g. flexible) polymeric mold. The methods of cleaning compositions can be utilized with other (e.g. microstructured) devices and articles such as for example, electrophoresis plates with capillary channels and lighting applications. While the present invention is not so limited, an appreciation of various aspects of the invention will be gained through a discussion of methods, apparatus and articles for the manufacture of barrier ribs for PDPs.

The recitation of numerical ranges by endpoints includes all numbers subsumed within the range (e.g. the range 1 to 10 includes 1, 1.5, 3.33, and 10).

Unless otherwise indicated, all numbers expressing quantities of ingredients, measurements of properties, and so like as used in the specification and claims are to be understood to be modified in all instances by the term “about.”

(“Meth)acryl” refers to functional groups including acrylates, methacrylates, acrylamide, and methacrylamide.

“(Meth)acrylate” refers to both acrylate and methacrylate compounds.

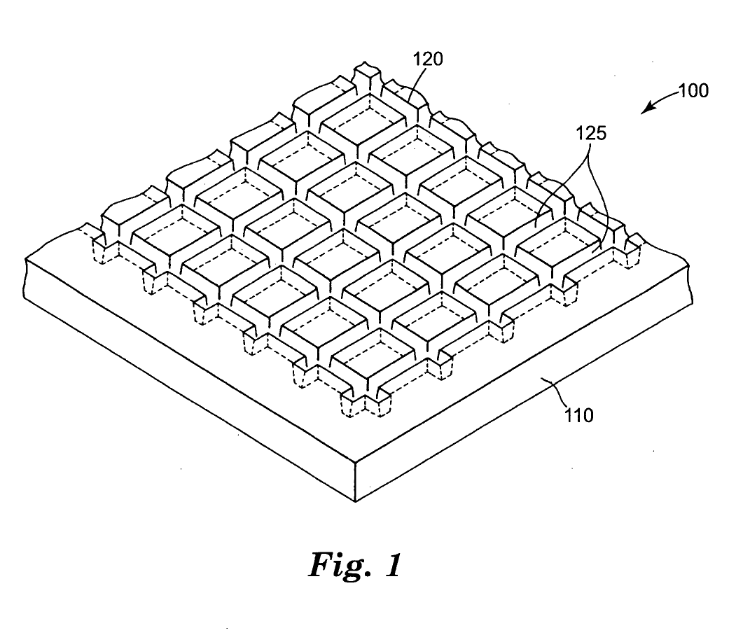

FIG. 1 is a partial perspective view showing an illustrative flexible mold 100. The flexible mold 100 generally has a two-layered structure having a planar support layer 110 and a microstructured surface, referred to herein as a shape-imparting layer 120 provided on the support. The flexible mold 100 of FIG. 1 is suitable for producing a grid-like rib pattern of barrier ribs on a (e.g. electrode patterned) back panel of a plasma display panel. Another common barrier ribs pattern (not shown) comprises plurality of (non-intersecting) ribs arranged in parallel with each other.

Although the support 110 may optionally comprise the same material as the shape-imparting layer for example by coating the polymerizable composition onto the transfer mold in an amount in excess of the amount needed to only fill the recesses, the support is typically a preformed polymeric film. The thickness of the polymeric support film is typically at least 0.025 millimeters, and typically at least 0.075 millimeters. Further the thickness of the polymeric support film is generally less than 0.5 millimeters and typically less than 0.175 millimeters. The tensile strength of the polymeric support film is generally at least about 5 kg/mm² and typically at least about 10 kg/mm². The polymeric support film typically has a glass transition temperature (Tg) of about 60° C. to about 200° C. Various materials can be used for the support of the flexible mold including cellulose acetate butyrate, cellulose acetate propionate, polyether sulfone, polymethyl methacrylate, polyurethane, polyester, and polyvinyl chloride. The surface of the support may be treated to promote adhesion to the polymerizable resin composition. One exemplary support is a polyethylene terephthalate (PET) based material having a surface that is formed according to the method described in U.S. Pat. No. 4,340,276; incorporated herein by reference.

The depth, pitch and width of the microstructures of the shape-imparting layer can vary depending on the desired finished article. The depth of the microstructured (e.g. groove) pattern 125 (corresponding to the barrier rib height) is generally at least 100 μm and typically at least 150 μm. Further, the depth is typically no greater than 500 μm and typically less than 300 μm. The pitch of the microstructured (e.g. groove) pattern may be different in the longitudinal direction in comparison to the transverse direction. The pitch is generally at least 100 μm and typically at least 200 μm. The pitch is typically no greater than 600 μm and typically less than 400 μm. The width of the microstructured (e.g. groove) pattern 125 may be different between the upper surface and the lower surface, particularly when the barrier ribs thus formed are tapered. The width is generally at least 10 μm, and typically at least 50 μm. Further, the width is generally no greater than 100 μm and typically less than 80 μm.

The thickness of an illustrative shape-imparting layer is generally at least 5 μm, typically at least 10 μm, and more typically at least 50 μm. Further, the thickness of the shape-imparting layer is generally no greater than 1,000 μm, typically less than 800 μm and more typically less than 700 μm. When the thickness of the shape-imparting layer is below 5 μm, the desired rib height for many PDP panels cannot be obtained. When the thickness of the shape-imparting layer is greater than 1,000 μm, warp and reduction of dimensional accuracy of the mold can result due to excessive shrinkage.

The flexible mold is typically prepared from a transfer mold, having a corresponding inverse microstructured surface pattern as the flexible mold. The transfer mold may have a microstructured surface comprised of a cured (e.g. silicone rubber) polymeric material, such as described in U.S. application Ser. No. 11/030,261 filed Jan. 6, 2005 (Docket No. 59452US002), incorporated herein by reference.

Flexible mold 100, can be used to produce barrier ribs on a substrate for a (e.g. plasma) display panel. Prior to use, the flexible mold or components thereof may be conditioned in a humidity and temperature controlled chamber (e.g. 22° C./55% relative humidity) to minimize the occurrence of dimensional changes during use. Such conditioning of the flexible mold is described in further detail in WO2004/010452; WO2004/043664 and JP Application No. 2004-108999, filed Apr. 1, 2004; incorporated herein by reference thereof.

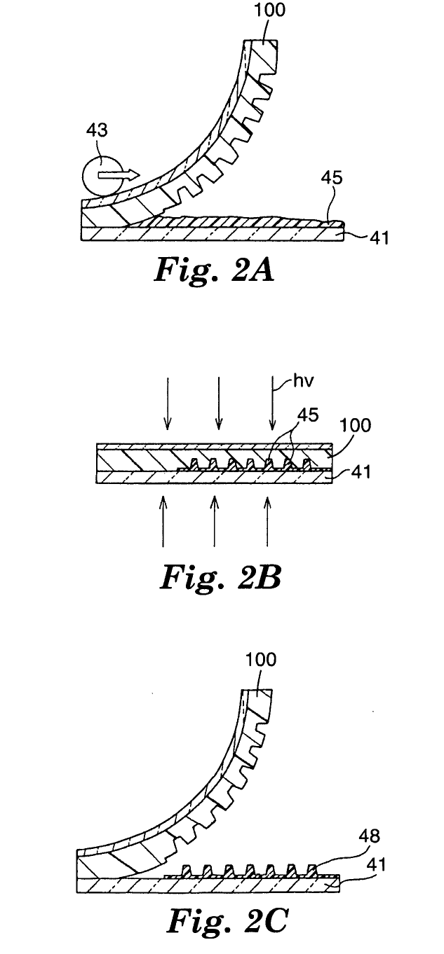

With reference to FIG. 2A, a flat transparent (e.g. glass) substrate 41, having an (e.g. striped) electrode pattern is provided. The flexible mold 100 of the invention is positioned for example by use of a sensor such as a charge coupled device camera, such that the barrier pattern of the mold is aligned with the patterned substrate. A barrier rib precursor 45 such as a curable ceramic paste can be provided between the substrate and the shape-imparting layer of the flexible mold in a variety of ways. The curable material can be placed directly in the pattern of the mold followed by placing the mold and material on the substrate, the material can be placed on the substrate followed by pressing the mold against the material on the substrate, or the material can be introduced into a gap between the mold and the substrate as the mold and substrate are brought together by mechanical or other means. As depicted in FIG. 2A, a (e.g. rubber) roller 43 may be employed to engage the flexible mold 100 with the barrier rib precursor. The rib precursor 45 spreads between the glass substrate 41 and the shape-imparting surface of the mold 100 filling the groove portions of the mold. In other words, the rib precursor 45 sequentially replaces air of the groove portions. Subsequently, the rib precursor is cured. The rib precursor is preferably cured by radiation exposure to (e.g. UV) light rays through the transparent substrate 41 and/or through the mold 100 as depicted on FIG. 2B. As shown in FIG. 2C, the flexible mold 100 is removed while the resulting cured ribs 48 remain bonded to the substrate 41.

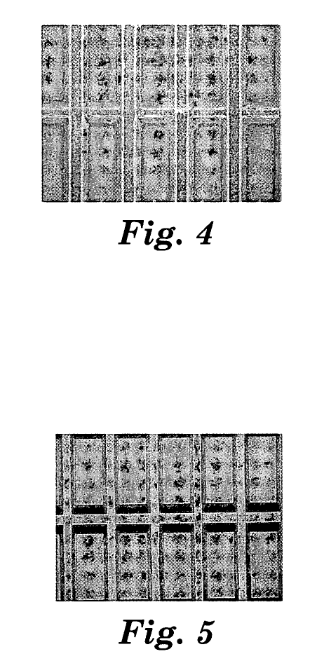

The flexible mold has a polymeric microstructured surface that is susceptible to build-up of the curable rib precursor and other contamination such as shown in FIG. 4. Although the flexible mold may comprise other (e.g. cured) polymeric materials, at least the microstructured surface of the flexible mold typically comprises the reaction product of a polymerizable composition which generally comprises at least one ethylenically unsaturated oligomer and at least one ethylenically unsaturated diluent. The ethylenically unsaturated diluent is copolymerizable with the ethylenically unsaturated oligomer. The oligomer generally has a weight average molecular weight (Mw) as determined by Gel Permeation Chromatography (described in greater detail in the example) of at least 1,000 g/mole and typically less than 50,000 g/mole. The ethylenically unsaturated diluent generally has a Mw of less than 1,000 g/mole and more typically less than 800 g/mole.

The method of cleaning the mold comprises providing a flowable solidifiable cleaning composition on the microstructured surface of the mold wherein the cleaning composition is different than the curable molding material; solidifying the cleaning composition; and removing the solidified cleaning composition.

As depicted in FIG. 5, microstructured mold suitable for reuse preferably has a roughness, as determined by the test method set forth in the examples of less than 1 micron, and more preferably less than 0.5 microns.

The kinds and amount of ingredients of the cleaning composition are preferably chosen such that the microstructures of the mold have substantially the same dimensions after cleaning. Accordingly, the extent of swelling of the microstructured surface of the flexible mold is less than 10% and more typically less than 5%, as can be determined by visual inspection with a microscope.

For embodiments wherein the rib precursor is cured through the flexible mold, the flexible mold is suitable for reuse when the flexible mold material is sufficiently transparent after cleaning. A sufficiently transparent mold material typically has a haze (as measured according to the test method described in the examples) of less than 15%, preferably of less than 10% and more preferably no greater than 5% after a single use.

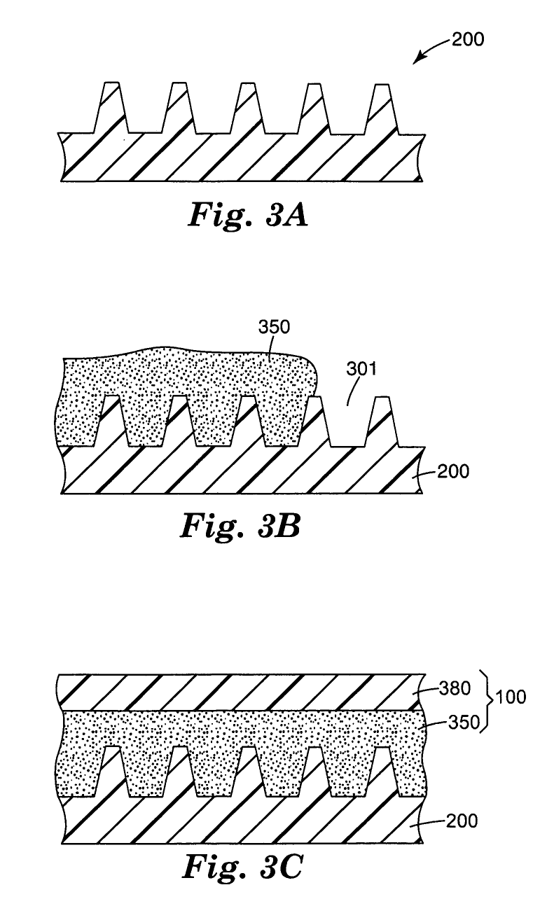

With reference to FIG. 3A-3C, an embodied method of cleaning a flexible mold (e.g. of FIG. 1), a polymerizable resin cleaning composition 350 is provided at least in the recesses of the microstructured surface of the flexible mold 200. This can be accomplished with known customary coating means such as a knife coater or a bar coater. A support 380 comprising a flexible polymeric film is stacked onto the mold having recesses filled with the polymerizable cleaning composition such that the cleaning composition contacts the support. While stacked in this manner, the polymerizable resin cleaning composition is cured. Photocuring is typically preferred. For this embodiment, it is preferred that the support as well as the polymerizable cleaning composition are sufficiently optically transparent such that rays of light irradiated for curing can pass through the support. Once cured, the cured cleaning composition 100, having support film 380 integrally bonded is separated from the flexible mold 200.

In the embodied method just described, the microstructured mold is cleaned in the same manner as the microstructured mold is produced. As an alternative to use of a support, the cleaning composition may be coated in excess such that a continuous layer is formed above the recesses filled with the cleaning composition. This continuous layer can serve the same function as the support. In yet another aspect, a thermoplastic material may be employed as an alternative to a polymerizable resin composition. The thermoplastic material is heated to a liquid state to fill the recess of to the mold and then cooled to a hardened state.

The curable rib precursor (also referred to as “slurry” or “paste”) comprises at least three components. The first component is a glass- or ceramic-forming particulate material (e.g. powder). The powder will ultimately be fused or sintered by firing to form microstructures. The second component is a curable organic binder capable of being shaped and subsequently hardened by curing, heating or cooling. The binder allows the slurry to be shaped into rigid or semi-rigid “green state” microstructures. The binder typically volatilizes during debinding and firing and thus may also be referred to as a “fugitive binder”. The third component is a diluent. The diluent typically promotes release from the mold after hardening of the binder material. Alternatively or in additional thereto, the diluent may promote fast and substantially complete burn out of the binder during debinding before firing the ceramic material of the microstructures. The diluent preferably remains a liquid after the binder is hardened so that the diluent phase-separates from the binder material during hardening.

The cleaning compound differs from the curable rib precursor. In some aspects, the cleaning composition comprises the same ingredients as the rib precursor, yet differs in the concentration of such ingredients. In other aspects, the cleaning composition comprises at least one different ingredient than the rib precursor. This cleaning composition may comprise more ingredients or less ingredients than the rib precursor.

The cleaning composition typically comprises a curable organic binder, optionally in combination with a diluent and optionally in combination with a particulate material.

The rib precursor and the cleaning composition preferably has a viscosity of less than 20,000 cps and more preferably less than 10,000 cps to adequately fill all the microstructured groove portions of the flexible mold. It is typically preferred that the cleaning composition be provided in the microstructured groove portions in a manner to minimize the entrapment of air (e.g. oxygen). However, it may be useful to provide a cleaning composition foam by inclusion of inert gas.

Various curable organic binders can be employed in rib precursor and cleaning composition. The curable organic binder is curable for example by exposure to radiation or heat. The polymerizable composition of the rib precursor and cleaning composition is preferably radiation curable. “Radiation curable” refers to functionality directly or indirectly pendant from a monomer, oligomer, or polymer backbone (as the case may be) that react (e.g. crosslink) upon exposure to a suitable source of curing energy. It is typically preferred that the binder of at least the rib precursor is radiation curable under isothermal conditions (i.e. no change in temperature).

Photocurable rib precursor and cleaning compositions comprise one or more photoinitiators at a concentrations ranging from 0.01 wt-% to 1 wt-% of the polymerizable resin composition. Suitable photointitiators include for example, 2-hydroxy-2-methyl-1-phenylpropane-1-one; 1-[4-(2-hydroxyethoxy)-phenyl]-2-hydroxy-2-methyl-1-propane-1-one; 2,2-dimethoxy-1,2-diphenylethane-1-one; 2-methyl-1-[4-(methylthio)phenyl]-2-morpholino-1-propanone; and mixtures thereof.

Representative examples of radiation crosslinkable groups include epoxy groups, (meth)acrylate groups, olefinic carbon-carbon double bonds, allyloxy groups, alpha-methyl styrene groups, (meth)acrylamide groups, cyanate ester groups, vinyl ethers groups, combinations of these, and the like. Free radically polymerizable groups are preferred. Of these, (meth)acryl functionality is typical and (meth)acrylate functionality more typical. Typically at least one of the ingredients of the polymerizable composition, and most typically the oligomer, comprises at least two (meth)acryl groups.

In general the curable organic binder of the rib precursor and/or cleaning composition may comprise various known oligomers including (meth)acrylated urethanes (i.e., urethane (meth)acrylates), (meth)acrylated epoxies (i.e., epoxy(meth)acrylates), (meth)acrylated polyesters (i.e., polyester (meth)acrylates), (meth)acrylated (meth)acrylics, (meth)acrylated polyethers (i.e., polyether (meth)acrylates) and (meth)acrylated polyolefins. The oligomer(s) and monomer(s) preferably have a glass transition temperature (Tg) of about −80° C. to about 60° C., respectively, meaning that the homopolymers thereof have such glass transition temperatures.

The diluent is not simply a solvent compound for the oligomer of the rib precursor. The diluent is preferably soluble enough to be incorporated into the resin mixture in the uncured state. Upon curing of the binder of the slurry, the diluent should phase separate from the monomers and/or oligomers participating in the cross-linking process. Preferably, the diluent phase separates to form discrete pockets of liquid material in a continuous matrix of cured resin, with the cured resin binding the particles of the glass frit or ceramic powder of the slurry. In this way, the physical integrity of the cured green state microstructures is not greatly compromised even when appreciably high levels of diluent are used (i.e., greater than about a 1:3 diluent to resin ratio). This provides two advantages. First, by remaining a liquid when the binder is hardened, the diluent reduces the risk of the cured binder material adhering to the mold. Second, by remaining a liquid when the binder is hardened, the diluent phase separates from the binder material, thereby forming an interpenetrating network of small pockets, or droplets, of diluent dispersed throughout the cured binder matrix. In the case of the cleaning composition, the diluent typically does not phase separate.

The amount of curable organic binder of the rib precursor composition is typically at least 2 wt-%, more typically at least 5 wt-%, and more typically at least 10 wt-%. The amount of diluent in the cleaning composition is typically at least 2 wt-%, more typically at least 5 wt-%, and more typically at least 10 wt-%. The totality of the organic components is typically at least 10 wt-%, at least 15 wt-%, or at least 20 wt-%. Further, the totality of the organic compounds is typically no greater than 50 wt-%. The amount of inorganic particulate material is typically at least 40 wt-%, at least 50 wt-%, or at least 60 wt-%. The amount of inorganic particulate material is no greater than 95 wt-%. The amount of additive is generally less than 10 wt-%.

The cleaning compound may have the same concentration yet differ in the selection of the curable binder and/or diluent and/or inorganic particulate material. In some embodiments, the cleaning composition is substantially free of inorganic particulate materials. The cleaning composition may contain oligomer combined with the monomeric diluent(s) in amounts of 40 wt-% to 90 wt-% of the total polymerizable composition. In some embodiments, the amount of oligomer is at least 50 wt-%, at least 60 wt-%, or at least 70 wt-%.

In preferred embodiments, the cleaning composition comprises a curable binder, a diluent, and photoinitiator. Further, the diluent of the cleaning composition has a solubility parameter that is less than the curable organic binder.

The solubility parameter of various monomers, δ(delta), can conveniently be calculated using the expression:
δ=(ΔEv/V)^{1/2},
where ΔEv is the energy of vaporization at a given temperature and V is the corresponding molar volume. According to Fedors' method, the SP can be calculated with the chemical structure (R. F. Fedors, Polym. Eng. Sci., 14(2), p. 147, 1974, Polymer Handbook 4^{th} Edition “Solubility Parameter Values” edited by J. Brandrup, E. H. Immergut and E. A. Grulke).

The solubility parameter of the curable binder of the cleaning compound can be the same as the diluent. In some embodiments the curable binder of the cleaning compound has a higher solubility parameter than the diluent. The difference between the solubility parameter of the curable binder and the diluent is at least 1 [MJ/m³]^{1/2} and typically at least 2 [MJ/m³]^{1/2}. The difference between the solubility parameter of the curable binder and the diluent is preferably at least 3 [MJ/m³]^{1/2}, 4 [MJ/m³]^{1/2}, or 5 [MJ/m³]^{1/2}. The difference between the solubility parameter of the curable binder and the diluent is more preferably at least 6 [MJ/m³]^{1/2}, 7 [MJ/m³]^{1/2}, or 8 [MJ/m³]^{1/2}. The difference between the solubility parameter of the curable binder and the diluent is typically no greater than 20 [MJ/m³]^{1/2}.

Various organic diluents can be employed depending on the choice of curable organic binder. In general suitable diluents include various alcohols and glycols such as alkylene glycol (e.g. ethylene glycol, propylene glycol, tripropylene glycol), alkyl diol (e.g. 1,3 butanediol,), and alkoxy alcohol (e.g. 2-hexyloxyethanol, 2-(2-hexyloxy)ethanol, 2-ethylhexyloxyethanol); ethers such as dialkylene glycol alkyl ethers (e.g. diethylene glycol monoethyl ether, dipropylene glycol monopropyl ether, tripropylene glycol monomethyl ether); esters such as lactates and acetates and in particular dialkyl glycol alkyl ether acetates (e.g. diethylene glycol monoethyl ether acetate); alkyl succinate (e.g. diethyl succinate), alkyl glutarate (e.g. diethyle glutarate), and alkyl adipate (e.g. diethyl adipate).

The rib precursor and cleaning compound may optionally comprise various additives including but not limited to surfactants, catalysts, etc. as known in the art. For example, the rib precursor may comprise 0.1 to 1 parts by weight of a phosphorus-based compound alone or in combination with 0.1 to 1 parts by weight of a sulfonates based compounds. Such compounds are described in PCT Patent Application US04/26701;

incorporated herein by reference. Further, the rib precursor may comprise an adhesion promoter such as a silane coupling agent to promote adhesion to the substrate (e.g. glass panel of PDP).

The glass- or ceramic-forming particulate material (e.g. powder) of the rib precursor is chosen based on the end application of the microstructures and the properties of the substrate to which the microstructures will be adhered. One consideration is the coefficient of thermal expansion (CTE) of the substrate material (e.g. glass panel of PDP). Preferably, the CTE of the glass- or ceramic-forming material of the slurry of the present invention differs from the CTE of the substrate material (e.g. electrode patterned glass panel of a PDP) by no more than 10%. When the substrate material has a CTE which is much less than or much greater than the CTE of the ceramic material of the microstructures, the microstructures can warp, crack, fracture, shift position, or completely break off from the substrate during processing. Further, the substrate can warp due to a high difference in CTE between the substrate and the fired microstructures. Inorganic particulate materials suitable for use in the slurry of the present invention preferably have coefficients of thermal expansion of about 5×10⁻⁶/° C. to 13×10⁻⁶/° C.

Glass and/or ceramic materials suitable for use in the rib precursor of the present invention typically have softening temperatures below about 600° C., and usually above 400° C. The softening temperature of the ceramic powder indicates a temperature that must be attained to fuse or sinter the material of the powder. The substrate generally has a softening temperature that is higher than that of the ceramic material of the rib precursor. Choosing a glass and/or ceramic powder having a low softening temperature allows the use of a substrate also having a relatively low softening temperature.

Lower softening temperature ceramic materials can be obtained by incorporating certain amounts of lead, bismuth, or phosporous into the material. Suitable composition include for example i) ZnO and B₂O₃; ii) BaO and B₂O₃; iii) ZnO, BaO, and B₂O₃; iv) La₂O₃ and B₂O₃; and v) Al₂O₃, ZnO, and P₂O₅. Other low softening temperature ceramic materials are known in the art. Other fully soluble, insoluble, or partially soluble components can be incorporated into the ceramic material of the slurry to attain or modify various properties.

The preferred size of the particulate glass- or ceramic-forming material of the rib precursor depends on the size of the microstructures to be formed and aligned on the patterned substrate. The average size, or diameter, of the particles is typically no larger than about 10% to 15% the size of the smallest characteristic dimension of interest of the microstructures to be formed and aligned. For example, the average particle size for PDP barrier ribs is typically no larger than about 2 or 3 microns.

The cleaning compound may also comprise a particulate material. Such material may be included to improve the removeal of the cured cleaning composition. Particulate material increases the cohesive strength of the cured cleaning composition so failure doesn't occur during delamination leaving cleaning material in the mold. The particles in the cleaning composition can also be useful for modifying the viscosity properties.

Although the cleaning composition may comprise the same glass- or ceramic-forming particulate material as the rib precursor, since the cleaning composition is not subsequently sintered, most any particulate material may be employed. The particulate material may be an organic material, an inorganic material, or a combination thereof. Suitable particulate material include for example talc, clay, silica, alumina, titania, carbon, metal particles as well as polymeric particles such as PMMA, polystyrene, PET, PTFE, etc.

The amount of particulate material added to the cleaning composition is typically less than or equal to the amount of inorganic material of the rib precursor paste.

Various other aspects that may be utilized in the invention described herein are known in the art including, but not limited to each of the following patents that are incorporated herein by reference: U.S. Pat. No. 6,247,986; U.S. Pat. No. 6,537,645; U.S. Pat. No. 6,713,526; U.S. Pat. No. 6,843,952, U.S. Pat. No. 6,306,948; WO 99/60446; WO 2004/062870; WO 2004/007166; WO 03/032354; US2003/0098528; WO 2004/010452; WO 2004/064104; U.S. Pat. No. 6,761,607; U.S. Pat. No. 6,821,178; WO 2004/043664; WO 2004/062870; PCT Application No. US2005/0093202,; PCT No. WO2005/019934; PCT No. WO2005/021260; PCT No. WO2005/013308; PCT No. WO2005/052974; PCT Publication No. WO2005/068148; U.S. patent application Ser. Nos. 11/203,908; 11/204,206; 11/204,207; 11/203,909, each filed Aug. 15, 2005; and U.S. patent application Ser. Nos. 11/107,554 and 11/107,608, both filed Apr. 15, 2005; U.S. patent application Ser. No. 11/185,194, filed Jul. 20, 2005; U.S. patent application Ser. No. 11/237,810, filed Sep. 28, 2005.

The present invention is illustrated by the following non-limiting examples.

### EXAMPLES

The ingredients employed in the examples are described in Table 1 as follows:

TABLE 1

| | | Trade | |
|---|---|---|---|
| | | Designation | |
| Chemical Name | Vendor Name | Abbreviation | Function |
| γ-methacryloxypropyl | Nippon Unicar | A174 | Primer for glass |
| trimethoxysilane | Co., Ltd. | | substrate |
| Polyether based urethane | Daicel-UCB Co., | EB 270 | Oligomer |
| acrylate | Ltd | | |
| Polyester based urethane | Daicel-UCB Co., | EB 8402 | Oligomer |
| acrylate | Ltd | | |
| Dimethacrylate of | Kyoeisya | Epoxyester 40EM | Oligomer |
| ethylene glycol diglycidyl | Chemical Co., | | |
| ether | Ltd. | | |
| Diacrylate of glycerin | Kyoeisya | Epoxyester | Oligomer |
| diglycidyl ether | Chemical Co., | 80MFA | |
| | Ltd. | | |
| Dimethacrylate of | Kyoeisya | Epoxyester | Oligomer |
| bisphenol A diglycidyl | Chemical Co., | 3000M | |
| ether | Ltd. | | |
| Dimethacrylate of | Kyoeisya | Epoxyester | Oligomer |
| propylene oxide modified | Chemical Co., | 3002M | |
| bisphenol A diglycidyl | Ltd. | | |
| ether | | | |
| Hydrogenated | Osaka Organic | SPBDA | Oligomer |
| polybutadiene diacrylate | Chemical | | |
| | Industry, Ltd. | | |
| Phenoxyethylacrylate | Osaka Organic | POA | Diluent |
| | Chemical | | |
| | Industry, Ltd. | | |
| ε-caprolactone modified | Daicel Chemical | FA2D | Diluent |
| hydroxyalkylacrylate | Industry | | |
| Hexadecane | Tokyo Kasei | Hexadecane | Diluent |
| | Kogyo Co., Ltd | (“HD”) | |
| 1, 3-butane-diol | Wako Pure | 1, 3-butane-diol | Diluent |
| | Chemical | (“1, 3-BD”) | |
| | Industries, Ltd. | | |
| Ethylene-glycol | Wako Pure | Ethylene-glycol | Diluent |
| | Chemical | (“EG”) | |
| | Industries, Ltd. | | |
| Dipropylene Glycol | Wako Pure | DPPG | Diluent |
| | Chemical | | |
| | Industries, Ltd. | | |
| Dipropylene Glycol | Nippon Nyukazai | PFDG | Diluent |
| Monopropyl Ether | Co., Ltd. | | |
| Tri-propylene glycol | Tokyo Kasei | TPPG | Diluent |
| | Kogyo Co., Ltd. | | |
| 2-Propanol | Wako Pure | IPA | Diluent |
| | Chemical | | |
| | Industries, Ltd. | | |
| Polyethyleneglycol | Kao Corp. | Emulgen 103 | Diluent |
| monolauryl ether | | | |
| Polyethyleneglycol | Kao Corp. | Emulgen 404 | Diluent |
| monooleyl ether | | | |
| Ethoxyethoxyethyl acetate | Wako Pure | EtEtEtAc | Diluent |
| | Chemical | | |
| | Industries, Ltd. | | |
| Basic acrylic polymer | Kyoeisya | DOPA-17 | Stabilizer |
| | Chemical Co., | | |
| | Ltd. | | |
| 2-hydroxy-2-methyl-1- | CIBA Specialty | Darocur 1173 | Photoinitiator |
| phenylpropane-1-one, | Chemical | | |
| 1-[4-(2-hydroxyethoxy)- | CIBA Specialty | Irgacure 2959 | Photoinitiator |
| phenyl]-2-hydroxy-2- | Chemical | | |
| methyl-1-propane-1-one | | | |
| bis(2, 4, 6- | CIBA Specialty | Irgacure 819 | Photoinitiator |
| trimethylbenzoyl)- | Chemical | | |
| phenylphosphine-oxide | | | |
| 2, 4, 6-trimethylbenzoyl- | BASF | Lucirin TPO | Photoinitiator |
| diphenylphosphine-oxide | | | |
| Lead borosilicate glass | Asahi Glass Co., | RFW-401C2 | Filler |
| powder | Ltd. | | |
| Lead borosilicate glass | Asahi Glass Co., | RFW-030 | Filler |
| powder | Ltd. | | |

Measurement of Haze

A 50 mm by 50 mm size sample of the smooth surface mold was measured in a haze meter (NDH-SENSOR) manufactured by Nippon Densyoku Industries, Co., in accordance with ISO-14782. The haze values provided in the examples are an average of 5 sample measurements.

Measurement of Surface Roughness

A 40 micron by 100 micron sample area was viewed through a 20×lense of a laser microscope VK9500 manufactured by KEYENCE Corp. The surface roughness was measured at a depth interval of 0.2 microns and the Arithmatic Mean Deviation of the Profile (Ra) was calculated according to JIS B 0601-1994.

Preparation of Unstructured Test Surface

In order to evaluate the efficacy of various cleaning compositions, it was found useful to test the interaction between various cleaning compositions and various unstructured mold materials. A test surface was prepared from 90 parts by weight (pbw) of Ebecryl 8402 acrylated urethane oligomer, 10 pbw of ε-caprolactone modified hydroxyalkylacrylate monomer and 1 pbw of Irgacure 2959 photoinitiator mixed at ambient temperature and coated on 188 microns polyester film (PET) support with the thickness of 300 microns. The coated surface was laminated to a 38 micron release PET liner and cured with 1,700 mj/cm² of ultraviolet light through the PET liner with a fluorescent lamp having a peak wavelength at 352 nm (manufactured by Mitsubishi Electric Osram LTD). After removing the release liner, Unstructured Mold Material A (having the cured polymerizable resin on the PET support) was obtained. The haze of Unstructured Mold Material A was 6.0+/−1.0%.

Unstructured Mold Material B was prepared in the same manner as except that the polymerizable composition contained 80 pbw of Ebecryl 270, 20 pbw of POA monomer and 1 pbw of Darocur 1173 photointiator. The haze of was 6.0+/−1.0%.

Preparation of Microstructured Molds

Microstructured Mold MS-1 was prepared in the same manner as Unstructured Test Surface A except that the resin mixture was coated on 250 microns PET support, then it was laminated to a mold having a concave lattice pattern on its surface and cured through the PET support. The microstructure of the mold used for lamination had the following lattice concave pattern.
Vertical grooves; 1,845 lines, 300 micron pitch, 210 micron height, 110 micron of groove bottom width (rib top width), 200 micron of groove top width (rib bottom width)
Lateral grooves; 608 lines, 510 micron pitch, 210 micron height, 40 micron of groove bottom width (rib top width), 200 micron of groove top width (rib bottom width)
The surface roughness (Ra) of mold MS-1 was 0.2+/−0.1 micron.

Mold MS-2 was obtained by the same method as MS-1, except the resin mixture was the same as Mold-B. The surface roughness (Ra) of mold MS-2 was 0.2+/−0.1 micron.

Preparation of the Molds for Evaluation of the Cleaning Performance

A tray filled with glass frit (RFW-030) manufactured by Asahi Glass Co., Ltd was provided and the unstructured mold materials and microstructured molds were placed smooth or microstructured side down into the frit and the tray was shaken. The mold was then removed from the tray with frit adhered onto its surface creating a dirty mold. The glass frit adhered strongly to the surface of the mold via static forces. Attempts to remove the adhered frit by high pressure air were unsuccessful. The haze of both dirty unstructured mold materials A and B was 70.0+/−10.0%. The surface roughness (Ra) of the dirty microstructured molds, MS-1 and MS-2, was 1.0+/−0.2 micron.

Preparation of the Cleaning Compositions

Each of the cleaning compositions set forth in the examples were prepared by combining the kinds and amounts of oligomer, diluent and initator set forth in Table 2 and mixing the ingredients at ambient temperature.

Method of Evaluating the Cleaning Performance

For evaluating Unstructured Mold Materials A and B, each of the cleaning compositions of Table 2 was coated on 38 microns corona-treated PET film with the thickness of 250 microns and was laminated to the coated glass by use of a roller. The curable cleaning resin composition was cured with 0.16 mW/cm² light by irradiating through the flexible mold for 3 minutes with a fluorescent lamp having a peak wavelength at 400-500 nm (Philips). The mold was then separated leaving the cured cleaning composition bonded to the glass substrate.

The cleaning performance was evaluated by measuring the haze of the cleaned mold. When the haze of the mold was less than 15.0%, the surface of the mold was found to be adequately cleaned.

For evaluating Microstructured Mold MS-1 and MS-2, each of the cleaning compositions of Table 2 was coated onto a primed 2.8 mm glass substrate (PD200 from Asahi Glass Co., Ltd.) at a thickness of 250 microns. The microstructed mold was laminated to the coated glass by use of a roller. The cleaning composition was cured with 0.16 mW/cm² light by irradiating through the flexible mold for 3 minutes with a fluorescent lamp having a peak wavelength at 400-500 nm (Philips). The mold was then separated leaving the cured cleaning composition bonded to the glass substrate.

TABLE 2

| | | | | | Unstructured Mold | | Microstructured Mold | |
|---|---|---|---|---|---|---|---|---|
| | | | Ratio | Photo Initiator | Material (Haze %) | | Roughness (Ra) (micron) | |
| Sample | Oligomer (SP) | Diluent (SP) | (wt %) | (0.7 wt %) | Mold A | Mold B | Mold MS-1 | Mold MS-2 |
| Ex. 1 | 80MFA (28) | PFDG (19) | 90:10 | Irgacure 819 | 9.0 | | 0.18 | |
| Ex. 2 | 80MFA (28) | PFDG (19) | 60:40 | Irgacure 819 | 6.9 | 6.6 | 0.16 | 0.16 |
| Ex. 3 | 80MFA (28) | PFDG (19) | 40:60 | Irgacure 819 | 11.1 | | 0.22 | |
| Ex. 4 | 80MFA (28) | IPA (21) | 70:30 | Lucirin TPO | 6.2 | 6.2 | 0.15 | 0.24 |
| Ex. 5 | 80MFA (28) | 1,3-BD (26) | 60:40 | Irgacure 819 | 7.1 | 6.4 | 0.19 | 0.16 |
| Ex. 6 | 80MFA (28) | Emulgen 103 (19) | 60:40 | Lucirin TPO | 7.9 | 7 | 0.14 | 0.31 |
| Ex. 7 | 40EM (25) | DPPG (24) | 70:30 | Lucirin TPO | 7.6 | 5.9 | 0.17 | 0.31 |
| Ex. 8 | 40EM (25) | EtEtEtAc (18) | 70:30 | Lucirin TPO | 10.7 | 7.2 | 0.15 | 0.16 |
| Ex. 9 | 3000M (24) | TPPG (22) | 50:50 | Irgacure 819 | 7.1 | 6 | 0.14 | 0.29 |
| Ex. 10 | 3000M (24) | Emulgen 404 (19) | 50:50 | Irgacure 819 | 8.1 | 6.8 | 0.17 | 0.27 |
| Ex. 11 | 3002M (23) | PFDG (19) | 50:50 | Lucirin TPO | 8.6 | 5.7 | 0.15 | 0.11 |
| Ex. 12 | EB270 (20) | HD (16) | 85:15 | Irgacure 819 | 8.1 | 9.2 | 0.15 | 0.10 |
| Ex. 13 | SPBDA (17) | HD (16) | 85:15 | Darocur 1173 | 7.9 | 8.2 | 0.17 | 0.12 |
| Ex. 14 | 80MFA (28) | PFDG (19) | 95:5 | Irgacure 819 | 8.1 | | Not removable | |
| Ex. 15 | 80MFA (28) | PFDG (19) | 30:70 | Irgacure 819 | 43.6 | | Not removable | |
| Ex. 16 | 80MFA (28) | EG (30) | 60:40 | Irgacure 819 | 23.4 | 20.2 | 0.35 | Not removable |
| Ex. 17 | 3000M (24) | 1,3-BD (26) | 50:50 | Irgacure 819 | 10.6 | 34.9 | 0.28 | 0.54 |

### Example 18

Mold MS-3 was obtained by the same method as MS-1, except the resin mixture was 80 parts by weight (pbw) of Ebecryl 8402 acrylated urethane oligomer, 19 pbw of ε-caprolactone modified hydroxyalkylacrylate monomer and 1 pbw of Irgacure 2959 photoinitiator. The surface roughness (Ra) of mold MS-1 was 0.2+/−0.1 micron.

Rib paste was prepared by mixing the liquid ingredients, 7.63 pbw of 80MFA curable binder, 7.63 pbw of PFDG diluent, and 0.95 pbw of DOPA-17 stabilizer together. Then 84 parts by weight (pbw) glass frit (RFW-401C2) manufactured by Asahi Glass Co., Ltd, and 0.11 pbw of Irgacure 819 photoinitiator were added to the liquid mixture and mixed with a Conditioning Mixer AR-250 (manufactured by THINKY Corporation) at ambient temperature until homogeneous.

The rib paste was coated onto a primed 2.8 mm glass substrate (PD200 from Asahi Glass Co., Ltd.) at a thickness of 250 microns. The microstructed mold MS-3 was laminated to the coated glass by use of a roller. The rib precursor was cured with 0.16 mW/cm² light by irradiating through the flexible mold for 30 seconds with a fluorescent lamp having a peak wavelength at 400-500 nm (Philips). The mold was then separated leaving the cured barrier ribs bonded to the glass substrate.

The procedure was repeated 20 times using the same microstructed mold MS-3. The build up of dirt on the mold was measured using a laser microscope, VK9500 manufactured by KEYENCE Corp, to be between 2 to 3 microns in thickness.

A cleaning composition was prepared by combining 96.7 pbw of 80MFA oligomer, 2.5 pbw of PFDG diluent and 0.8 pbw of Irgacure 819 initiator and mixing the ingredients at ambient temperature.

This cleaning composition was coated onto a primed 2.8 mm glass substrate (PD200 from Asahi Glass Co., Ltd.) at a thickness of 250 microns. The microstructed mold MS-3 was laminated to the coated glass by use of a roller. The cleaning composition was cured with 0.16 mW/cm² light by irradiating through the flexible mold for 3 minutes with a fluorescent lamp having a peak wavelength at 400-500 nm (Philips). The mold was then separated leaving the cured cleaning composition bonded to the glass substrate.

The surface roughness (Ra) of the mold after cleaning was measured. The Ra of mold was 0.3 micron. Thus, the surface of the mold was found to be adequately cleaned and thus, the cleaned mold is suitable for reuse.

### Examples 19-20

The addition of filler to the cleaning composition was evaluated based on cleaning performance.

For Example 19, a cleaning composition was prepared in the same manner as for Example 2 except that an additional 6 parts by weight (pbw) AEROSIL R974 was added as a filler. The cleaning performance was evaluated by measuring % haze and surface roughness (Ra) on all four molds. The % haze for both Mold A and Mold B was 5.8% and 6.2% respectively, thus the surface of the mold was found to be adequately cleaned. The surface roughness (Ra) of the Mold MS-1 and MS-2 was 0.11 and 0.23 microns respectively, thus the surface of the microstructured mold was found to be adequately cleaned.

For Example 20, Mold MS-3 was prepared for cleaning using the same process as described in Example 14. A picture of the prepared mold is included in FIG. 4.

A cleaning composition containing filler was prepared in the same manner as the rib paste as described in Example 18 except the cleaning composition contained 15.2 pbw of 80MFA oligomer, 3.8 pbw of PFDG diluent, 0.95 pbw of DOPA-17 stabilizer, 80 parts by weight (pbw) glass frit (RFW-401C2, and 0.11 pbw of Irgacure 819 photoinitiator. This cleaning composition was coated onto a primed 2.8 mm glass substrate (PD200 from Asahi Glass Co., Ltd.) at a thickness of 250 microns. Microstructed mold MS-3 was laminated to the coated glass by use of a roller. The cleaning composition was cured with 0.16 mW/cm² light by irradiating through the flexible mold for 3 minutes with a fluorescent lamp having a peak wavelength at 400-500 nm (Philips). The mold was then separated leaving the cured cleaning composition bonded to the glass substrate. The cleaned mold was determined to be adequately cleaned base on microscopic inspection, refer to FIG. 5.

What is claimed:

1. A method of making a display panel component comprising:
a) providing a mold having a polymeric microstructured surface suitable for making barrier ribs;
b) providing a curable rib precursor composition between the microstructured surface of the mold and a substrate;
c) curing the rib precursor composition;
d) removing the mold;
e) cleaning the mold by
providing a flowable solidifiable cleaning composition on the microstructured surface of the mold wherein the cleaning composition is different than that the rib precursor composition;
solidifying the cleaning composition; and
removing the solidified cleaning composition;
reusing the cleaned mold to repeat steps a)-d).

2. The method of claim 1 wherein the mold has a roughness of less than 1 micron after cleaning.

3. The method of claim 1 wherein the microstructured surface of the mold has microstructures of dimensions that have substantially the same dimensions after cleaning.

4. The method of claim 1 wherein the mold is flexible.

5. The method of claim 1 wherein the polymeric microstructured surface of the mold comprises a cured polymeric material.

6. The method of claim 5 wherein cured polymeric material comprises the reaction product of at least one (meth)acrylate oligomer and at least one (meth)acrylate monomer.

7. The method of claim 5 wherein the polymeric microstructured surface is disposed on a polymeric support film.

8. The method of claim 1 wherein the rib precursor composition comprises photoinitiator and the rib precursor composition is photocured through the substrate, though the mold, or a combination thereof.

9. The method of claim 1 wherein the mold is transparent and solidifying the cleaning composition comprises photocuring.

10. The method of claim 1 wherein the cleaning composition comprises ingredients selected from a curable organic binder, optionally a diluent and optionally a particulate material and wherein the cleaning composition comprises at least one ingredient that is different than the rib precursor or the same ingredients as the rib precursor at different concentrations.

11. The method of claim 10 wherein the particulate material is an inorganic material.

12. The method of claim 11 wherein the rib precursor comprises an inorganic particulate material and the amount of the inorganic material in the cleaning composition is less than the amount of inorganic material in the rib precursor composition.

13. The method of claim 1 wherein the cleaning composition comprises a curable organic binder having a solubility parameter, at least one diluent having a solubility parameter that is equal to or less than the solubility parameter of the curable organic binder, and at least one initiator.

14. The method of claim 13 wherein the solubility parameter of the diluent is less than the curable organic binder by a difference of greater than 2 [MJ/m³]^{1/2}, a difference of at least 5 [MJ/m³]^{1/2}, or a difference of greater than 8 [MJ/m³]^{1/2}.

15. The method of claim 13 wherein the curable organic binder comprises at least one (meth)acryl oligomer comprising at least two (meth)acryl groups.

16. The method of claim 15 wherein the (meth)acryl oligomer is selected from a (meth)acrylated epoxy, (meth)acrylate urethane, (meth)acrylated polyether, (meth)acrylated polyester, (meth)acrylated polyolefin, (meth)acrylated (meth)acrylic, and mixtures thereof.

17. The method of claim 1 wherein the cleaning composition is substantially free of inorganic particulate materials.

18. A method of cleaning a mold comprising:
a) providing a mold having a polymeric microstructured surface suitable for use in molding a curable molding material;
b) cleaning the mold by
providing a flowable solidifiable cleaning composition on the microstructured surface of the mold wherein the cleaning composition is different than the curable molding material;
solidifying the cleaning composition; and
removing the solidified cleaning composition.
